(19) United States
(12) Patent Application Publication
(10) Pub. No.: US 2018/0376075 A1
(43) Pub. Date: Dec. 27, 2018

(54) METHOD AND SYSTEM FOR RECORDING VIDEO DATA USING AT LEAST ONE REMOTE-CONTROLLABLE CAMERA SYSTEM WHICH CAN BE ALIGNED WITH OBJECTS

(71) Applicant: Antony PFOERTZSCH, Bremen (DE)

(72) Inventor: Antony PFOERTZSCH, Bremen (DE)

(21) Appl. No.: 16/054,456

(22) Filed: Aug. 3, 2018

Related U.S. Application Data
(63) Continuation of application No. PCT/EP2017/062744, filed on May 26, 2017.

(30) Foreign Application Priority Data
May 30, 2016 (EP) 16172016.4

(51) Int. Cl. H04N 5/232; G06T 7/246; G06F 3/01; B64C 39/02

(52) U.S. Cl. CPC H04N 5/23299; H04N 5/23206; G06T 7/248; B64C 2201/127; B64C 39/024; B64C 2201/123; G06F 3/017

(57) ABSTRACT

The present disclosure is directed to a method for recording video data using at least one camera system orientable to objects. The method comprises registering an information processing device on a server with registration data, transmitting parameters for the camera system from the information processing device to the server, transmitting the parameters or the parameters changed by the server from the server to the camera system, and recording video data on a camera of the camera system during orientation of the camera system on the basis of the parameters.

Further, the present disclosure relates to a system for recording video data and to a server, a camera system and an information processing device for such a system.

### BACKGROUND

### Technical Field

The invention relates to a method and a system for recording video data using a camera of a camera system, which camera is orientable to objects, in particular by means of actuators of the camera system that are connected to the camera.

### Description of the Related Art

The ever more progressive development for camera systems means that many professional film-makers and also hobbyist film-makers today are using complex camera systems comprising, by way of example, remote-controlled, semi-autonomously acting vehicles, such as drones which are also called copters. Such camera systems allow sports contests or even acrobatic performances, for example, to be filmed from perspectives that are not possible using a conventional handheld camera.

By way of example, camera systems comprising a drone can be used to film skiing contests, such as a skiing slalom, and to track individual people for this at a very short distance.

However, the ever increasing distribution means that the use of such camera systems is frequently limited to certain areas, so that no risk can emanate from the flying drones. Nevertheless, hobbyist and professional film-makers often disregard the area restriction and are therefore a danger to the performers and further spectators. The risk emanating from such camera systems therefore means that the use of the systems is prohibited in many public and private event areas.

Risks emanating from the camera systems, for example, with a drone, are that such systems leave safe areas on account of malfunctions or as the user intends, and this can lead to collisions, or even crash on account of a malfunction.

However, it is desirable to be able to use such camera systems in the future in order to provide the extraordinary video shoots of particular interest to the spectator, without putting spectators and also performers, such as sportsmen, at risk.

### BRIEF SUMMARY

Various embodiments of the present disclosure provide a way of providing camera systems orientable to objects for recording video data that are not a risk to people.

The present disclosure is directed to a system and method for recording video data. The system includes a camera system, an information device, and a server. The camera system includes an unmanned vehicle, such as a drone, and a camera that is orientable to target objects. The information processing device is registered on the server using registration data, and transmits parameters for the camera system to the server. The server may update received parameters according to various user preferences. For example, the parameters may be updated to instruct the camera system to record a particular object, stay within a particular area, or begin recording at a particular time. The server transmits the parameters to the camera system, which records video data with the camera on the basis of the parameters.

### BRIEF DESCRIPTION OF THE SEVERAL VIEWS OF THE DRAWINGS

Further embodiments arise on the basis of the exemplary embodiments described in more detail in the figures, in which:

FIG. 1 shows an exemplary embodiment of the system according to an embodiment of the present disclosure,

FIG. 2 shows an exemplary embodiment of an information processing device,

FIG. 3 shows a further exemplary embodiment of an information processing device,

FIG. 4 shows a rear view of the information processing device from FIG. 3,

FIG. 5 shows a magnified depiction of the camera system from FIG. 1 in the ground position,

FIG. 6 shows the camera system from FIG. 5 in flight,

FIG. 7 shows an alternative exemplary embodiment of the camera system with an unmanned land vehicle,

FIG. 8 shows a further alternative exemplary embodiment of the camera system with an unmanned cable vehicle,

FIG. 9 shows steps of an exemplary embodiment of the method,

FIGS. 10 to 13 show further steps of exemplary embodiments of the method.

FIG. 14 shows a plan view of a camera system performing a video shoot,

FIG. 15 shows a further plan view of a camera system performing a video shoot, and

FIG. 16 shows a camera system controlled by a gesture.

### DETAILED DESCRIPTION

The present disclosure relates to a method and a system for recording video data using at least one camera system orientable to objects. In one embodiment, registration data are transferred or transmitted from at least one information processing device, for example a mobile device, such as a cell phone, tablet PC, computer or the like, which is preferably Internet-compatible, to a server and, as a result, the information processing device is registered on the server. That is to say that a server is provided on which a user can register with an information processing device by transferring registration data. The registration data may have been stored in the information processing device by a user beforehand, for example, or said user can input them into the information processing device. The registration data are then transferred from the information processing device to the server, preferably via a wireless data connection between the information processing device and the server.

Status information of one or more camera systems connected to the server via, for example, a radio connection is then preferably output to the information processing device. Such status information is the position and availability of the camera system(s), for example.

According to one embodiment, it is then possible for parameters, for example for controlling the camera system, to be selected or specified via a user. The parameters for controlling the camera system are transmitted from the information processing device to the server. After the server has received the parameters for controlling the camera system, the server transmits the parameters or parameters changed by the server for control, to the camera system. Such parameters are, by way of example, the selecting of an object to which the camera is intended to be oriented, particular positions that the camera system is intended to adopt, and/or further functions that the camera system is intended to perform. In this case, parameters are direct control parameters, which can also be called control commands and are intended to be executed by the camera system directly, or indirect control parameters, which comprise presets for a behavior of the camera system, the camera system acting essentially autonomously, but taking into consideration the indirect control parameters, by means of its own sensors.

Further, video data are recorded using the camera system, while the camera of the camera system orients itself to the object on the basis of the parameters or the parameters changed by the server for control.

It is thus possible to perform video recordings using camera systems provided by an operator of a sports event, for example. These camera systems receive parameters, in particular for orienting them, from the server rather than directly from a user input device, such as an ordinary remote control.

Therefore, the user can admittedly affect the control of the camera system using an information processing device via the circuitous route of the server, the organizer being able to prescribe fixed limits by means of the server, for example for area restrictions for the camera system. These stipulations may not be circumvented by a user.

Accordingly, the operation of private camera systems, for example not originating from the organizer, can be prohibited, and the organizer himself can ensure that correctly serviced and therefore correctly working camera systems are used, which further reduces the risk of an accident. Moreover, the organizer can stipulate area restrictions for the camera system to prevent them from entering danger zones.

Preferably, it is also possible for multiple camera systems to be selected by the user, which the user can control via the server at the same time, in succession, or periodically. The camera systems can use the previously transmitted parameters to also independently plan the shoot and, preferably in successive periods one after the other or at the same time, to film, record, or shoot at least one predetermined object, a respective predetermined sector or a respective predetermined location.

According to a first embodiment of the present disclosure, a recording time or a recording period is also transferred or transmitted with the registration data, which comprise a user name and a password, for example, from the information processing device to the server at the same time or afterwards. That is to say that a user can input a desired recording time or a recording period, for example using input means of the information processing device, and these are then transferred to the server. Subsequently, the server then outputs to the information processing device a time for an availability for a recording time or a recording period or a period before an availability. In this case, the time or the period is dependent on status information of the camera system, on one or more previously transmitted recording times or recording periods, and on the currently transmitted recording time or the currently transmitted recording period.

If, according to this embodiment, multiple camera systems are connected to the server, the server outputs to the information processing device a time for an availability or a period before an availability of at least one of the multiple camera systems. In this case, the time or the period is dependent on status information of the multiple camera systems, on one or more previously transmitted recording times or recording periods, and on the currently transmitted recording time or the currently transmitted recording period.

As a result, by way of example, a private user who wants to have himself filmed traveling through a skiing area in which the system is available, for example, can plan desired times for the video shoot. If the remotely controllable camera system is still in use by a previous user, for example, then the desired shooting time is moved and the time at which the shoot can begin is determined by the server and communicated to the user by transmitting the time to the information processing device. As a result, the “new” user can already estimate when the recording of video data for himself will begin. The specifying of the desired recording time is thus used to also provide subsequent users with the opportunity to plan a time for the recording.

According to a further embodiment, the recorded video data are transmitted from the camera to the server and from the server to a predetermined destination continuously during the shoot and/or after a shoot has ended. A predetermined destination may be a computer connected to the server via an Internet connection or a device connected to the server via a data and/or video connection, for example. Alternatively or additionally, the video data are all transmitted to the information processing device directly from the camera system or the server continuously during the shoot and/or after a shoot has ended.

In the event of multiple camera systems being used, the video data of all the camera systems are accordingly all transmitted to the information processing device directly from the camera systems or the server continuously during the shoot and/or after a shoot has ended. According to a particularly preferred embodiment, the server already makes a preselection for the shoots and transmits the preselected shoots to the information processing device or to the Internet.

By way of example, the user can use the information processing device to specify a predetermined destination, such as a social network, a video platform, or an email address, and can then have himself filmed traveling through a skiing area, for example. At the end of the period of the recording, which has been ascertained previously by the server, the video data are then transmitted from the server directly to the predetermined destination, and the user can look at the video corresponding to the video data, for example, in front of his home computer. Alternatively, it is also possible for the video data to be transmitted to further spectators desiring real time tracking of the recording, directly during the recording.

According to a further embodiment, the camera system is used to record positions of the object(s) in image details at the same time. These can later be used for the further processing of the video data by a user and, to this end, made available to a user at the same time as the video data.

According to a further embodiment, the camera system is repositionable to one or more sectors being stipulated for the camera system. For example, the parameters that have been transmitted from the information processing device to the server may comprise details for one or more of the sectors into which the camera system is repositioned once or repeatedly in a prescribed order or which restrict(s) the repositioning of the camera system.

In one embodiment, sectors, which can also be referred to as areas, are in particular geographically restricted areas stipulated by, for example, coordinates. In this case, a sector in which the camera system is repositionable is conceivable, or multiple individual, preferably adjacent, sectors are conceivable that restrict the repositioning of the camera.

The sectors are, for example, to go back to the aforementioned example of the skiing area again, lateral areas outside a navigable skiing surface. Moreover, the sectors are chosen such that they do not project into an area in which spectators may be, for example. When there are multiple camera systems used, there is preferably also provision for one respective camera system to be used in each of multiple non-overlapping sectors, so that repositionable cameras are restricted to their allocated sectors and therefore the risk of a collision is reduced.

According to a further embodiment, the camera system comprises an unmanned vehicle, such as an aircraft and/or land vehicle, for repositioning the camera system. For example, the unmanned vehicle may be an unmanned flying object, in particular a drone, such as a copter (e.g., a quadrocopter or an octocopter). Unmanned vehicles allow particularly flexible repositioning of the camera of a camera system.

According to a further embodiment, the parameters transmitted from the information processing device to the server and from the server to the camera system comprise a safe flying or traveling area consistent with a predetermined subregion of one or more of the sectors, and additionally or alternatively a starting sector for the unmanned vehicle. In this case, the starting sector may be one of multiple sectors prescribed by the server, for example. On the basis of the parameters, the camera system is then repositioned by flying over or traveling over the flying or traveling area or flying to or traveling to the starting sector.

That is to say that the user can use the information processing device to prescribe a flying or traveling area by means of parameters, which the unmanned vehicle then flies through or travels through while performing a shoot with the camera. Alternatively or additionally, a starting sector is prescribable by means of parameters, which the vehicle flies to before the beginning of the video recording.

Accordingly, a flexible route, restricted apart from the sectors or areas, or starting position is freely selectable by a user.

According to a further embodiment, the unmanned vehicle, after reaching a starting sector, begins recording the video data after the unmanned vehicle receives a start signal. This start signal is either sent by the server and received by the camera system, or alternatively the start signal can be sent by the mobile device and sent directly to the camera system. According to a preferred alternative, the camera system has at least one sensor, with prescribed sensor signals of the sensor being evaluated as a start signal.

If there are multiple camera systems with unmanned vehicles, then accordingly each of the unmanned vehicles of the respective camera system, after reaching a respective starting sector, begins recording the video data after the respective unmanned vehicle, that is to say the respective camera system, receives a start signal. Accordingly, the start signals are either sent by the server and/or received by the camera systems.

If there are multiple camera systems, then, according to a preferred alternative, each camera system has at least one sensor, with prescribed sensor signals of the sensor being evaluated to initiate a start signal of the respective camera system. According to a further alternative embodiment, the start signal, which is interpreted by a camera system based on sensor signals, is transmitted to the server. The server then transmits the start signal to further camera systems that are preferably likewise intended to be involved in a shoot. Therefore, it is also possible, by way of example, for the start signal to be generated by one of the camera systems while another camera system begins shooting.

Accordingly, a user can position the flying object on a starting sector and, by generating a start signal, can begin the video recording at the instant at which an object of interest, for example, appears in the sector.

According to a further embodiment, the sensor is a microphone and the prescribed sensor signals are prescribed sounds converted into signals. Alternatively or additionally, the sensor is an imaging sensor, for example an infrared sensor or a video sensor. The prescribed sensor signals are then consistent with prescribed gestures or movements of a person or an object converted into signals. This allows the video recording to be started without further devices, such as the information processing device, for example.

It is possible, by way of example, for the prescribed sensor signal, in the case of a sensor that is a microphone, to be prescribed as the sound of an internal combustion engine of a vehicle. If a motor race is intended to be recorded, for example, the camera system is therefore positionable in a starting sector and begins to shoot video automatically as soon as a vehicle approaches this area and the sound of the internal combustion engine of the vehicle is detected.

The starting of the video recording is also advantageous for people who want to film themselves and, owing to their operating a piece of sports equipment, do not have a free hand to operate the information processing device in order to generate the start signal. In this case, the start signal can be communicated to the camera system by means of a gesture.

If multiple camera systems are intended to be used for shooting, then, according to a further embodiment, there is provision for the sounds, gestures and/or movements detected as a result of prescribed sensor signals to be transferred to the server and/or further camera systems that are involved. Therefore, another camera system is controllable by means of a gesture or movement prescribed to one of the camera systems, for example.

According to a further embodiment, the parameters transmitted from the information processing device to the server and from the server to the camera system comprise a prescribed flying or traveling style, with the vehicle executing the prescribed flying or traveling style during the recording. Accordingly, by way of example, it is desirable—in order to make the video recording more relevant to different instances of application—for the camera system to move in a zigzag pattern or in a different manner a movement of its own independent of an object to be filmed within a selected sector. Further parameters are, for example, minimum distances to be observed from an object to be filmed or maximum speeds at which the camera system can reposition itself or at which a pan can be performed. The parameters can also be transferred in the form of neural networks, for example.

As a result, the camera system can reliably observe distances and speeds on the basis of its own sensor data independently of latency and connectivity to the outside world.

According to a further embodiment, the parameters transmitted from the information processing device to the server and from the server to the camera system comprise a predetermined object, wherein the vehicle tracks and/or follows the predetermined object during the flight or the journey and in so doing at least predominantly orients the camera to the selected object. The object is for example already selected and therefore predetermined using the information processing device during on the basis of a video shoot by the camera system that is transmitted to the information processing device.

As a result, it is not necessary for an entire sector to be recorded by the camera of the camera system, but rather an object of interest, which is predetermined, can be tracked in magnified depiction and the movement in detail can be recorded.

According to a further embodiment, the predetermined object is tracked by virtue of position identification data for the or a further information processing device being transferred to the server and/or the flying object during registration, and the flying object receiving the position identification data of the or the further information processing device during the flight directly or via the server and the positions identified in each case being used to orient the camera. Position identification data are GPS position data of a GPS receiver of the information processing device or of the further information processing device, for example.

Alternatively or additionally, the selected object is tracked by virtue of reference data of an object to be tracked being transferred with the parameters transmitted from the information processing device to the server and from the server to the camera system, and the reference data being compared with the sensor data of an imaging sensor, for example an infrared sensor or a video sensor, of the camera system in order to detect and track the selected object.

Reference data are the size, speeds, accelerations, heat signatures or color/contours of one or more objects, for example.

By way of example, the information processing device used for registration or a further information processing device, comprising a GPS receiver, is thus predetermined as an object and connected to the server or the flying object, so that the GPS position of the mobile device, which is a cell phone or a smart watch, for example, is transmitted directly to the server or the camera system. On the basis of the proper position of the camera system, which preferably likewise has a GPS receiver, the camera can now always be oriented to the position of the further information processing device. There is therefore no need for a user to intervene in the control during the video recording, so long as the information processing device transmits the position data or position identification data.

According to a further embodiment, the position of at least one predetermined object or location is transmitted to the server during or after the registration of the mobile device on the server. This can be effected directly, for example, in the form of GPS data of a GPS receiver of the object or by means of manual input on the information processing device. A location is predetermined by means of a selection on a virtual map depicted using the information processing device, for example. Additionally, the server then identifies one or more multiple camera systems that is or are most suitable for performing a shoot for the object or location.

The identification of the one or more multiple camera systems is performed either directly by the server, for example using a position database stored in the server with the current positions of multiple camera systems; or indirectly, in particular by position enquiry to and response for the current position from multiple camera systems. The server thus ascertains, for example directly or indirectly, which of the camera systems is particularly close to the predetermined object or location, this being performed by comparing the position of the object or location with the database or the response for the current positions of the camera systems, and thus identifies the closest camera system as the most suitable camera system.

If multiple suitable camera systems are identified, then the server preferably automatically decides which camera system is selected for shooting. Alternatively, it is also possible for a user to be able to make the selection. To this end, the suitable or all camera systems are displayed to the user on the information processing device, for example by means of a virtual map.

According to a further embodiment, reference data for at least one predetermined object are transmitted to the server during or after registration of the mobile device on the server. In this case, the predetermined object is consistent with an object that is predetermined by a user as an object of interest intended to be shot.

By way of example, reference data may include the size, the shape, the speed, the color, heat signatures or the like of the object, which are used generally to electronically detect the object, for example by means of image processing methods in a video image, and distinguish it from other objects.

The reference data are then transmitted from the server to multiple camera systems, the camera systems each reporting detection and/or non-detection of the object on the basis of the reference data to the server. Accordingly, each camera system checks, for example by means of image processing or processing of sensor data recorded using sensors, whether or not the predetermined object is detected in the active area, for example, that is to say in the visual range of the camera of the camera system, for example. Preferably, the server, for example automatically, or a user of one of the camera systems then selects that the object has been detected, in order to begin shooting video.

According to further embodiments, it is also possible for the user to select multiple camera systems, for example assigned to fixed sectors, and, after the beginning of video shooting using a first camera system, for another camera system to automatically continue shooting if the object leaves the shooting area of the first camera system and enters the shooting area of the other camera system.

According to a further embodiment, the server and/or one or more camera systems checks the video data of one or more camera systems for the presence of a predefined object on the basis of reference data for a predetermined object that have been transmitted by the user beforehand. The server and/or one or more camera systems then transmit(s) to the information processing device those recorded video data that have video sequences in which the predefined object is visible, that is to say present. A preselection of relevant video data is therefore made.

Further, the present disclosure is directed to a system for carrying out one or more of the aforementioned embodiments. Moreover, the present disclosure is directed to a camera system for the system. Further, the present disclosure is directed to a server for the system. Also, the present disclosure is directed to an information processing device for the system.

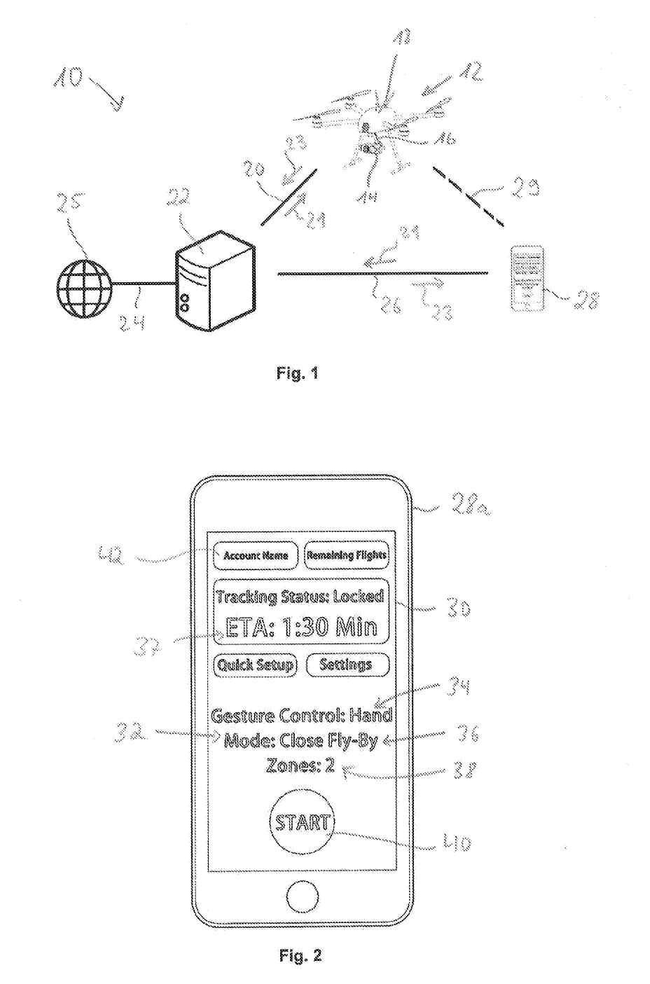

FIG. 1 shows an exemplary embodiment of the system 10 according to an embodiment of the present disclosure. The system 10 comprises a camera system 12 comprising a camera 14 coupled to an unmanned flying object 18 via one or more actuators 16. The unmanned flying object 18 is explained in detail later according to a particular embodiment.

The camera system 12 is connected to a server 22 via a data connection 20, which is preferably a radio connection, which is a mobile radio connection, for example. The server 22 can interchange data with the camera system 12 via the data connection 20. By way of example, the server 22 can send parameters 21 to the camera system 12 and retrieve status information 32 from the camera system 12. Further, video data recorded using the camera 14 are transmittable to the server 22 via the data connection 20.

Moreover, the server 22 is connected to the Internet 25 via a further data connection 24. The Internet connection of the server 22 is used, by way of example, to transmit video data that have been received with the camera 14 and transmitted from the camera system 12 to the server 22 via the data connection 20 to a predetermined destination on the Internet, such as a social network, a video platform, or an email address, for example.

Also, the server 22 is connected to an information processing device 28 via a data connection 26, which is likewise a radio connection, for example a mobile radio connection. Parameters 21 for the camera system 12 can accordingly be sent from the information processing device 28 to the server 22 via the data connection 26, and from the server 22 to the camera system 12 via the data connection 20. Moreover, the data connection 26 between the server 22 and the information processing device 28 can be used to send status information of the camera system 12, which status information has been transmitted to the server 22 via the data connection 20 beforehand, to the information processing device 28.

An optional further data connection 29 is used for transmission between the camera system 12 and the information processing device 28 directly. The data connection 29 between the camera system 12 and the information processing device 28 is used for transmitting a GPS signal or a comparable position signal of the information processing device 28, which can also be called a position identification signal and comprises position identification data, to the camera system 12, for example, in order to communicate the position of the information processing device 28 to the camera system 12. According to the exemplary embodiment depicted, the data connection 29 is depicted in dashes in order to express that it is optional. Alternatively, position data of the position signal just mentioned can also be transmitted from the information processing device 28 to the server 22 via the data connection 26 and from the server 22 to the camera system 12 via the data connection 20, for example.

FIG. 2 shows an information processing device 28a according to an exemplary embodiment. The information processing device 28a can be used in the system 10 depicted in FIG. 1. The information processing device 28a has a display 30 that is used to depict status information 32 of the flying object 18 that has been received from the server 22. The status information 32 comprises, for example, the currently set control mode 34 of a camera system 12, a shooting mode 36 of a camera system 12 or a sector display 38, which displays one or more areas or sectors within which the camera system 12 is repositionable and orientable. Besides the status information 32, the display 30, which is preferably touch sensitive, is used to provide a start button 40. The start button 40 can be used to output a start signal from the information processing device 28a to the server 22 via the data connection 26 in order either to steer the camera system 12 to a prescribed starting position or to start the recording of video data using the camera 14. Moreover, a time 37 from which the video shooting can begin is displayed.

Further, the display 30 depicts registration data 42 that, by way of example, are stored the information processing device 28a and transmitted to the server 22 via the data connection 26 by selection in order to register the information processing device 28a on the server 22. After registration, access to the server 22 and to one or more camera systems 12 connected to the server 22 possible. The information processing device 28a in FIG. 2 is consistent with a cell phone.

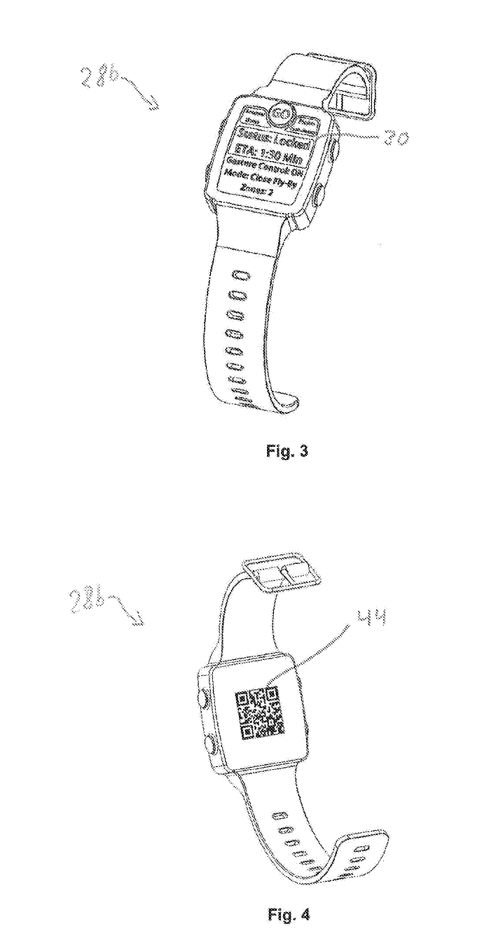

Alternatively or additionally, an information processing device according to another embodiment, namely in the form of a smart watch, is also possible. Such an information processing device 28b is depicted in FIG. 3. Similarly, the information processing device 28b depicted in FIG. 3 has a display 30 on which the identical information is depictable as previously on the information processing device 28a, as depicted in FIG. 2.

The information processing device 28b in FIG. 3 has a GPS receiver, not depicted, and is set up to transmit this GPS signal to the camera system 12 and/or the server 22, for example, via an antenna as a radio signal.

FIG. 4 shows the information processing device 28b, which is depicted in FIG. 3 and in this case consistent with a smart watch, from the rear. On the rear, the information processing device 28b has a scannable code 44. According to this exemplary embodiment, the information processing device 28b is permanently set up to transmit a GPS signal or a comparable position signal to the camera system 12. The camera system 12 is then configured to control the camera 14, by repositioning the camera system 12 by means of the unmanned flying object 18 and by orienting the camera 14 using the actuators 16, such that the position of the information processing device 28b is always substantially in the focus of the camera 14 of the camera system 12. That is to say that the camera system 12 tracks the information processing device 28b.

In order to generate a start signal from which tracking is intended to begin, it is possible, according to an embodiment, for the scannable code 44 to be scanned in by an information processing device 28a, as depicted in FIG. 2, for example, beforehand and transmitted to the server 22 together with registration data 42. This initializes the tracking of the information processing device 28b. Accordingly, although FIG. 1 depicts one information processing device 28, multiple information processing devices 28a, 28b, in particular based on different embodiments, namely firstly as a cell phone 28a and secondly as a smart watch 28b, are thus usable by a user within the system 10. The cell phone 28a is used as, by way of example, for registration, for transfer of parameters 21 and for retrieving of status information 32, and the smart watch 28b is used for providing the position signal.

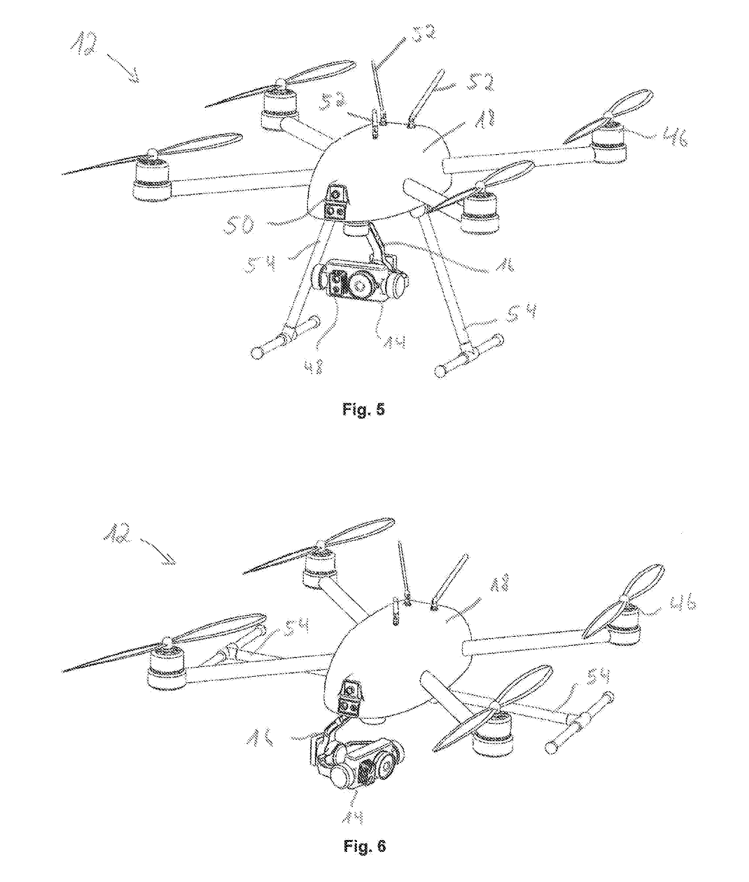

FIG. 5 shows a magnified depiction of the camera system 12, as depicted in FIG. 1. The camera system 12 comprises a camera 14 coupled via actuators 16 to an unmanned flying object 18, which in this case is consistent with a quadrocopter. The quadrocopter 18 has four rotors 46 in order to reposition quadrocopter 18 and the camera 14. The actuators 16 and the rotors 46 allow the camera 14 to be oriented to selected objects.

Additionally, the camera 14 has sensors 48, for example optical sensors or depth sensors, of the camera system 12 that are used firstly to focus the camera lens and secondly to allow orientation of the camera 14 with the actuators 16, which are controllable on the basis of the sensors 48. Accordingly, the sensors 48 are used, by way of example, to detect an object and to control the actuators 16 such that the lens of the camera 14 is pointed at the object that is intended to be detected. Therefore, independently or as an alternative to tracking a mobile device 28b, as depicted in FIGS. 3 and 4, for example, by means of the lens of the camera 14, which is oriented to the position data of the mobile device 28b, it is thus also possible for an orientation to be adjusted on the basis of a detected object by the sensors 48.

Further sensors 50, for example optical sensors or depth sensors, are arranged directly on the flying object 18 of the camera system 12, for example, in order likewise to track an object to be tracked by means of repositioning, that is to say by flying from one point to a further point, by virtue of these sensors 50 controlling the control of the rotors 46. The sensors 50 of the flying object 18 are moreover used in order to prevent a collision between the flying object 18 and obstacles, such as further camera systems 12. Further, the sensors 50 are preferably used also or as an alternative to optical navigation, also called optical odometry or SLAM methods. For this, according to an exemplary embodiment that is not depicted here, but included, there are still further sensors provided that are connected to the server 22, for example, and send the sensor data for determining the position of the camera system 12 to the server 22. The further sensors are external sensors arranged in the edge region of the sector(s), for example. Moreover, multiple antennas 52 are depicted in order to produce the different data connections 20, 29 to the server 22 and the information processing device 28. Moreover, the antennas 52 are used for receiving position data, for example from a GPS system, in order to establish the position of the camera system 12 itself.

To land safely, the camera system 12 has supporting feet 54. These can be folded up during the flight of the camera system 12 in order to ensure that the camera 14 is freely pannable by means of the actuators 16 in all directions. This is depicted in FIG. 6, for example.

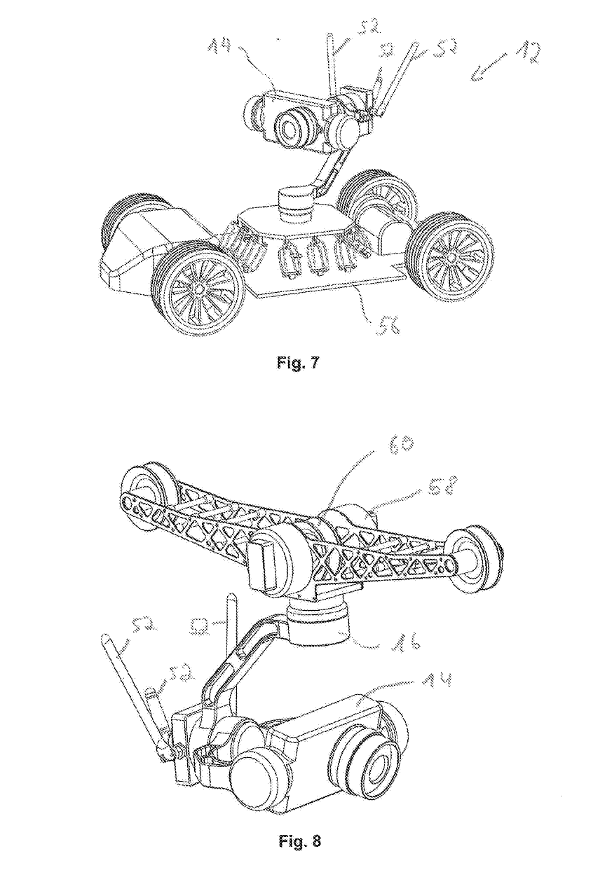

FIG. 7 shows an alternative exemplary embodiment of a camera system 12 that has an unmanned land vehicle 56 instead of an unmanned flying object. The land vehicle 56 also has antennas 52 by means of which the aforementioned data connections 20, 29 are able to be set up. To allow a better overview, sensors 48, 50 are not depicted further in FIG. 7, these likewise being part of the camera system 12.

A further alternative for a camera system 12 is depicted in FIG. 8. The camera system 12 in FIG. 8 is an unmanned cable vehicle 58 that is mountable on a cable and movable up and down on this cable. Similarly, the unmanned cable vehicle 58 is equipped with a drive 60 coordinating the movement of the vehicle 58. Again, the vehicle has the camera 14 and the actuators 16 provided on it, which allow orientation of the camera 14.

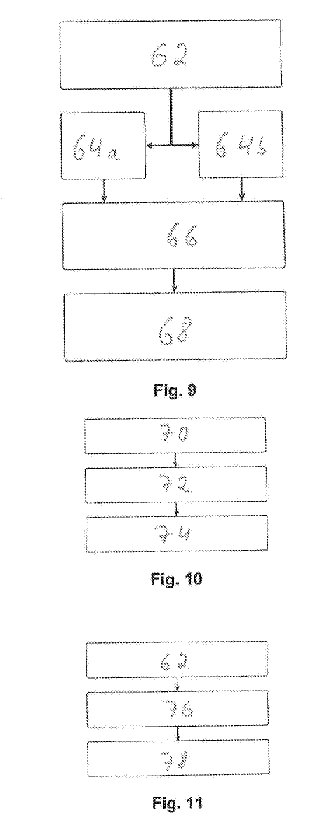

FIG. 9 shows an overview of the steps of an exemplary embodiment of the method according to the invention. In a first step 62, an information processing device 28a, 28b is registered, in particular by transmitting registration data 42. Next, in steps 64a, 64b parameters 21 for controlling the camera system 12 are transmitted from the information processing device 28a, 28b to the server 22. This either involves prescribed parameters 21 provided by the server 22 for selection with the information processing device 28a, 28b being transmitted 64a or a user transmits 64b user-specific parameters 21. Steps 64a, 64b may be performed concurrently as shown in FIG. 9, or may be performed sequentially (e.g., step 64b may be executed subsequent to step 64a). Next, in step 66, the parameters 21 or parameters 21 changed by the server 22 are transmitted to the camera system 12. After the transmission 66 of the parameters 21 from the server 22 to the camera system 12, in step 68, the camera system 12 begins recording, the camera 14 being oriented and the camera system 12 being positioned or repositioned on the basis of the parameters 21 or changed parameters 21.

FIG. 10 depicts further steps of an exemplary embodiment of the method. The video data recorded during the recording in step 68 are sent to the server 22 in step 70 in real time or after a video recording has ended. Step 72 then relates to the case in which the server 22 has multiple camera systems 12 having one or more information processing devices 28 of different users connected to it, and each information processing device 28 is assigned to one or more camera systems 12. In this step, the server 22 assigns the video sections or video data recorded using the respective camera systems 12 to the applicable information processing devices 28 or to those destinations for the video data that are stored for the mobile data 28. This is accomplished using the registration data and identification data of the camera systems 12. After the assignment in step 72, the video data are then transmitted to the applicable information processing devices 28 or destinations in a next step 74.

FIG. 11 shows a further exemplary embodiment of the method in which the registration in step 62 involves not only registration data 42 but also a desired recording time input by a user or a recording period desired by a user being transmitted from the information processing device 28 to the server 22. In the subsequent step 76, the server 22 receives the recording request and takes requests and utilization level of the camera system(s) 12 as a basis for planning a point in time or a period before the one, more or all camera system(s) 12 is/are available. In step 78, the time or the period before the camera system 12 or multiple camera systems 12 is/are available is then transmitted to the information processing device 28. Steps 76 and 78 are performed before steps 64a, 64b, for example according to the method that has been described for FIG. 9.

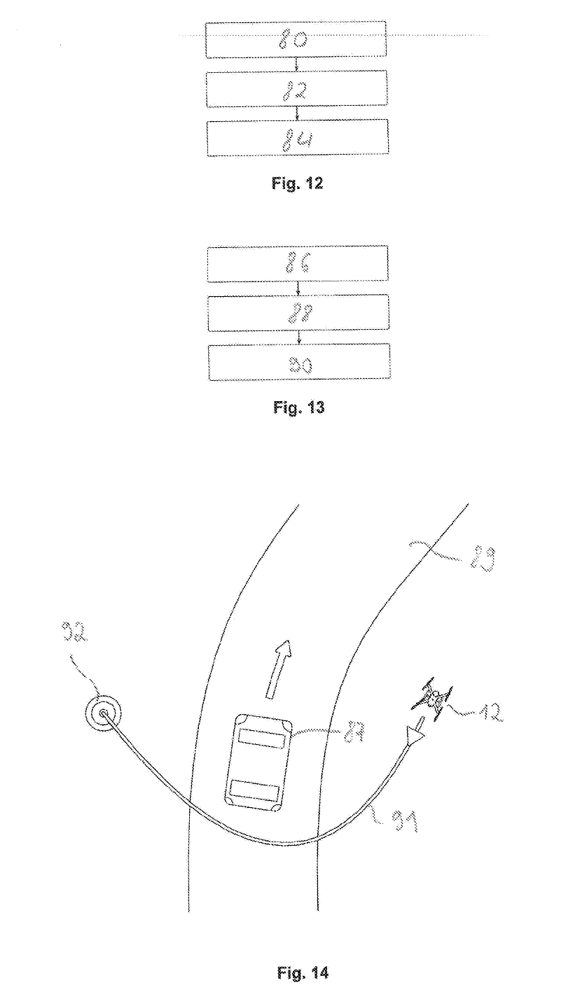

According to a further exemplary embodiment of the method, depicted in FIG. 12, the parameters 21 or changed parameters 21, for example a desired flying style, details about an object to be filmed or a desired starting position, and one or more selected sectors, are received by the camera system 12 in step 80, which is performed after step 66, as depicted in FIG. 9.

In step 82, the camera system 12 is then oriented and repositioned on the basis of the parameters 21. This involves, by way of example, a flight of an unmanned flying object 18 being performed dynamically by means of position data of the flying object 18 and/or a position signal of a user that is provided by an information processing device 28. In this case, a movement occurs on the basis of a chosen flying style, transmitted with the parameters 21 beforehand. Moreover, as already explained for step 68 in FIG. 9, video shoots are performed and preferably transmitted to the server 22.

In step 84, either a previously desired recording period or a recording time has now elapsed or a user who has previously provided a GPS system for repositioning the camera system 12 leaves a predefined area 38. As a result, the camera system 12 returns to a waiting position, which is preferably a charging station. The status of the camera system 12 is changed again in this case such that the camera system 12 is available for a further video recording. The status is transmitted to the server 22 in the form of status information 32.

According to a further exemplary embodiment of the method, depicted in FIG. 13, the transfer of the parameters 21 for control in steps 64a, 64b, according to FIG. 9, involves zones, areas or sectors to be monitored being transferred for the camera system 12. In step 86, which is depicted in FIG. 13, various sectors, for example prescribed entry areas, are then monitored by the camera system 12. In step 88, moving and/or warm objects (e.g., a body having a temperature above a predetermined threshold) are picked up by means of sensors 48, 50 of the camera system 12 and the camera 14 is pointed at these objects. In step 90, the pickup and tracking of these objects is then ended as soon as they leave the prescribed sector or area indicated, for example, in the sector display 38. The camera system 12 then reverts to step 86 and monitors the prescribed sector.

FIG. 14 shows an object 87 moving along a road 89, which is a racetrack, for example. The camera system 12 moves on the flight path 91 on the basis of the previously prescribed flying style while the camera 14, which is not visible here, is always oriented to the object 87 and films it. When it has arrived at point 92, the camera system 12 awaits a further object 87, for example, and at the same time it observes flight rules, which are preferably prescribed by the server 22, such as avoiding flying directly over the objet 87 in this case.

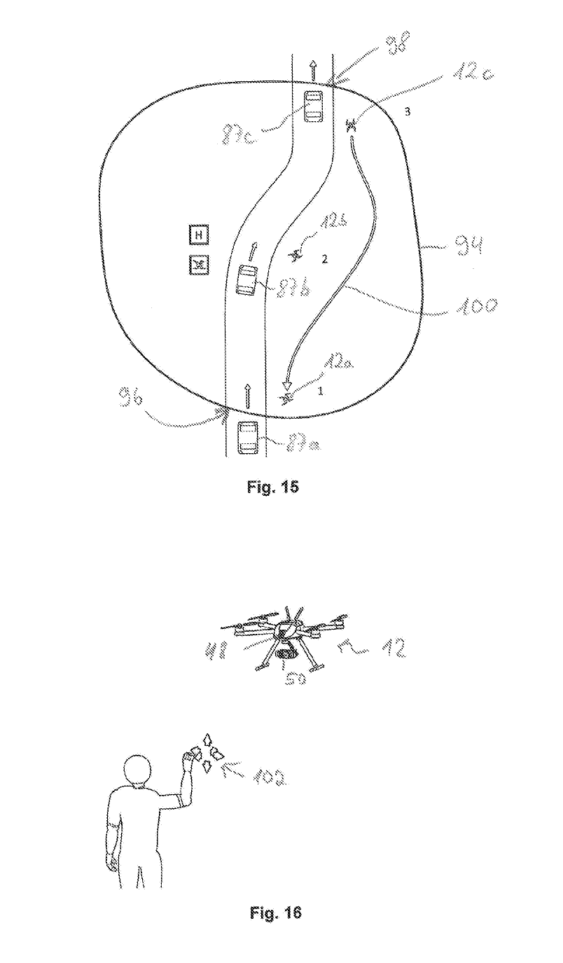

FIG. 15 depicts that the camera system 12 has an associated sector 94 that the camera system 12 cannot leave. This is catered for by the control of the camera system 12 via the server 22. Thus, even if a user wishes to leave this sector 94 and were to prescribe this by means of parameters 21 or position data, for example, such parameters 21 are not transmitted to the camera system 12, since it is controlled by the server 22, which limits the parameters 21.

The example in FIG. 15 depicts three camera systems 12a-12c. The camera system 12a monitors an entry area 96 of the sector 94. When the object 87a arrives, the camera system 12a begins to track the object 87a until it leaves the sector 94 in the exit area 98. The camera system 12b is currently tracking the object 87b, and the camera system 12c has tracked the object 87c to the exit of the sector 94. After the object 87c now leaves the sector 94, the camera system 12c returns to the entry area 96 on the flight path 100 and, at said entry area, awaits a new object 87 coming into the sector 94.

FIG. 16 shows a further alternative way of affecting the repositioning or the start of a shoot via the camera system 12. To this end, gestures 102, which are two dimensional and/or three dimensional, are recorded by the sensors 48, 50 and processed to produce commands. It is thus possible, for example, for the distance between the camera system 12 and an object 87 that is to be tracked to be varied. These effects on the control are possible to a limited extent, however, since the main control of the camera system 12 is provided by the server 22, which ensures, by way of example, that the camera system 12 does not leave predetermined sectors 94 even if this is prescribed by gestures 102.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method for recording video data using at least one camera system orientable to objects, the method comprising:
registering an information processing device on a server with registration data;
transmitting parameters for the at least one camera system from the information processing device to the server
transmitting the parameters from the server to the at least one camera system; and
recording, by a camera of the at least one camera system, video data during orientation of the camera system on the basis of the parameters.

2. The method of claim 1, further comprising:
transmitting a recording time or a recording period, and the registration data from the information processing device to the server;
determining, by the server, an availability of the camera system on the basis of the recording time or the recording period, and on the basis of status information of the at least one camera system; and
transmitting the availability of the camera system from the server to the information processing device.

3. The method of claim 1, further comprising:
transmitting the video data from the at least one camera system to the server, and from the server to a predetermined destination or the information processing device; or
transmitting the video data from the at least one camera system directly to the information processing device, continuously during the recording or after the recording has ended.

4. The method of claim 1, wherein the at least one camera system is repositionable, one or more sectors for positions of the camera are stipulated, and the parameters includes details for the one or more sectors in which the at least one camera system is repositioned once or repeatedly in a prescribed order, or which restricts the repositioning of the camera.

5. The method of claim 1, wherein the camera system includes an unmanned vehicle, the method including:
repositioning the camera system with the unmanned vehicle.

6. The method of claim 5, wherein the parameters include a traveling area or a starting sector for the unmanned vehicle, and repositioning of the camera system includes the unmanned vehicle traveling within the traveling area or traveling to the starting sector.

7. The method of claim 6, wherein the video data is recorded in response to the unmanned vehicle reaching the starting sector and the at least one camera system receiving a start signal from the server or the information processing device.

8. The method of claim 6, wherein
the video data is recorded in response to a start signal,
the start signal is initiated based on prescribed sensor signals of a sensor of the camera system, and
the sensor is a microphone and the prescribed sensor signals are consistent with prescribed noises converted into signals, or the sensor is an imaging sensor and the prescribed sensor signals are consistent with prescribed gestures or movements of a person or an object that are converted into signals.

9. The method of claim 1, wherein the parameters include a prescribed flying style or traveling style, the method including:
executing, by the camera system, the prescribed flying style or traveling style during the recording.

10. The method of claim 1, wherein the parameters include a predetermined object, the method including:
tracking, by the camera system, the predetermined object during the recording.

11. The method of claim 10, wherein
the predetermined object is tracked based on position identification data of the information processing device, the position identification data is transmitted to the server or the camera system, and the at least one camera system receives the position identification data directly or via the server; or
the predetermined object is tracked based on reference data of the predetermined object and sensor data of an imaging sensor of the at least one camera system.

12. The method of claim 1, further comprising:
transmitting a position of at least one predetermined object to the server during or after the registration of the information processing device on the server; and
identifying, by the server, a camera system of a plurality of camera systems to record the at least one predetermined object based on current positions of the plurality of camera systems.

13. The method of claim 1, further comprising:
transmitting reference data of at least one predetermined object to the server during or after the registration of the information processing device on the server;
transmitting, by the server, the reference data to multiple camera systems; and
reporting, by the multiple camera systems, detection or nondetection of the at least one predetermined object on the basis of the reference data to the server.

14. The method of claim 1, further comprising:
transmitting, by a user, reference data for at least one predetermined object to the server;
examining, by the server, the video data for the presence of the at least one predefined object on the basis of the reference data; and
transmitting, by the server, video sequences of the video data in which the at least one predefined object is visible.

15. A system for recording video data using a camera system orientable to objects, the system comprising:
at least one information processing device;
a server, the at least one information processing device and the server are configured to register the at least one information processing device on the server with registration data; and
at least one camera system, the information processing device and the server are configured to transmit parameters for the camera system from the information processing device to the server and to transmit the parameters from the server to the camera system, the at least one camera system includes a camera and actuators configured to orient the camera on the basis of the parameters while the camera records video data.

16. The system as claimed in claim 15, wherein the system includes multiple camera systems.

17.-19. (canceled)
